(19) United States
(12) Patent Application Publication
(10) Pub. No.: US 2023/0334157 A1
(43) Pub. Date: Oct. 19, 2023

(54) System, Method, and Apparatus for Expedited Deliver

(71) Applicant: PC Matic, Inc., SIOUX CITY, IA (US)

(72) Inventor: Andrew G. Tuch, Boca Raton, FL (US)

(73) Assignee: PC Matic, Inc., SIOUX CITY, IA (US)

(21) Appl. No.: 17/721,051

(22) Filed: Apr. 14, 2022

(51) Int. Cl. G06F 21/57; G06F 21/56; G06F 21/55

(52) U.S. Cl. CPC G06F 21/577; G06F 21/554; G06F 21/564; G06F 21/568

(57) ABSTRACT

A system for computer security includes security software running on a user device. The security software has a local data for control of the security software (e.g., whitelists, blacklists, virus detection files). A server has storage containing master data for control of the security software. Upon initialization of the security software, the security software connects to the server by way of a persistent connection. After receipt of a refresh message over the persistent connection, the security software downloads the master data and updates the local data from the master data.

### FIELD

This invention relates to the field of cloud computing and more particularly to a system for expedited delivery of files from cloud systems.

### BACKGROUND

The use of cloud computing has become ubiquitous. Cloud storage is used to safely store backup files, corporate databases, user files such as photographs, or just about anything that was previously stored locally to a home or office computer, previously in local mass storage.

Currently, many software systems attempt to provide a secure computing environment to a large variety of systems and devices such as computers, smartphones, notepads, smartwatches, etc. Protection software is typically loaded on these systems and devices that recognizes viruses and thwarts attempts at loading, storing, or executing of viruses or other malware. As virus and malware evolves, the protection software must evolve as well to be aware of new virus strains and new forms of malware. As new viruses and malware are found, entries or scripts are added to files used by the protection software in the detection and prevention of viruses and malware. In the past, the protection software evolved by periodically accessing a central server to see if new protection files are available, downloading the new protection file when they are available. As most devices are now connected to a network and have access to the Internet, the protection files are often stored in cloud storage to enable concurrent distribution to a large number of devices. As such, when administrators make a change to one of the protection files stored in cloud storage, eventually all devices will have access to the updated protection files, but not instantaneously.

As an example of the above, some protection software limits execution of programs to those on a list of allowed programs. When a user requests that an administrator allow execution of a new program, the administrator adds that program to the protection files, then while in communications with the user, the administrator often wishes to make sure the change to the protection files works as expected and the user is able to run the program, but due to various activities with cloud computing, it often takes several minutes before the protection file is distributed to all protected systems. This results in longer than needed interactions between the user and administrator as the communications between them need be open until the new protection file appears on the user’s device and, as this often takes several minutes, the user must periodically check to see if the program can be run.

What is needed is a system that will cause the protection software to pull down the protection file in real-time.

### SUMMARY

Distribution of files/settings such as virus protection files is a difficult task. For example, security software such as antimalware software periodically checks to see if new virus protection files are available. In the past, such checking was performed on a daily or weekly basis or on-demand when users are notified of an important update. Now with modern, high-speed data communications to protected devices, checking is performed more regularly, perhaps every ten minutes. Although ten minutes does not seem like a long time, when an end-user desires to run an application that is not currently in a whitelist and the administrator has added that application to the master whitelist, the end-user will have to wait up to ten minutes to see the change and the administrator often needs to continue communications with the end-user during that time to make sure the change to the whitelist did what was expected. Further, when a particularly dangerous malware is uncovered, every minute that this malware has the opportunity to infect user devices adds to the risk of such infection. Still further, it is often desired to update files such as whitelists and blacklist concurrently across a population of user devices, for example, all user devices in a company, or all user devices in a department.

As cloud computing becomes more prevalent, especially for use in distributing certain security software updates, the time gap between a change to a security software update in the cloud (e.g., a master file, settings) and delivery of the security software update to many user devices is of issue. For one, this time lag creates frustration between the end users and the administrators, as changes to permissions are not immediately available at the devices of the user. Further, although a short interval, when critical updates are made to the security software, the time between the updates to the cloud and distribution to all devices leaves a window of opportunity for attacks by malware.

In one embodiment, a system for computer security is disclosed including security software running on a user device. The security software has a local file or settings for control of the security software (e.g., whitelists, blacklists, virus detection files). A server has storage containing a master file for control of the security software. Upon initialization of the security software, the security software connects to the server by way of a persistent connection. After receipt of a refresh message over the persistent connection, the security software downloading the master file and updating the local file or settings from the master file.

In another embodiment, a method of protecting a user device, that has a processor is disclosed including installing security software on the user device. The security software runs on the processor after the user device is initialized and reads a local data file or settings to control access of the user device to resources (e.g., programs, network resources). Upon initialization of the security software on the processor, the security software makes a persistent connection to a server. When receiving a refresh message over the persistent connection, the security software downloads a master data file and updates the local data file and/or settings from the master data file.

In another embodiment, computer readable instructions for providing security to a user device are tangibly embodied in a non-transitory storage medium are disclosed including computer readable instructions running on a processor of the user device after the user device is initialized, the computer readable instructions reading a local data file to control access of the user device to resources. Upon initialization, the computer readable instructions running on the processor creates a persistent connection to a server and when the computer readable instructions running on the processor receives a refresh message over the persistent connection, the computer readable instructions running on the processor downloads a master data file and updates the local data file and/or settings from the master data file.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of the system for remote computer command execution.

FIG. 2 illustrates a schematic view of a typical end-point device controlled by the system for remote computer command execution.

FIG. 3 illustrates a schematic view of a typical server computer system.

FIG. 4 illustrates an exemplary program flow of the system for expedited delivery.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

In general, the system for expedited delivery initiates fast downloads of cloud files that have been recently updated, in particular, virus protection files.

Throughout this description, the term, “computer” refers to any system that has a processor and runs software. One example of such is a personal computer. Another example is a smartphone or tablet. The term, “user” refers to a human that has an interest in the computer, perhaps a user who is using the computer.

In general, the user of the system, method, and apparatus being described utilizes cloud systems for distribution of virus prevention files and data such as whitelist, blacklists, virus scanner settings, and virus detection files.

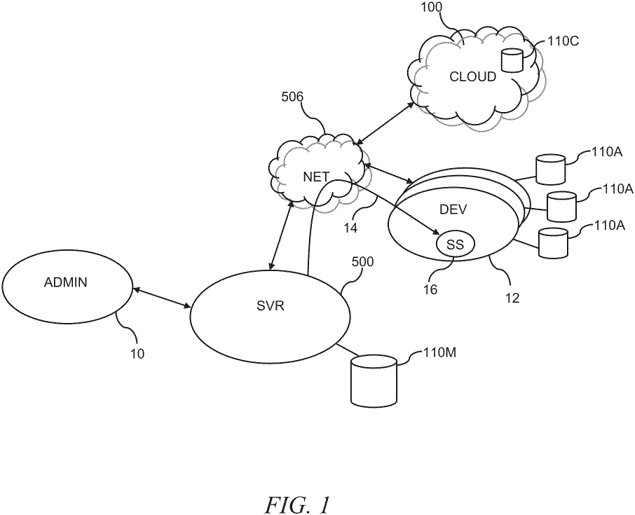

Referring to FIG. 1 illustrates a data connection diagram of the exemplary system for expedited delivery. In this example, a master file 110M is stored in a storage of a server 500 and manipulated by an administrator device 10, by an administrator. As an example, the master file 110M includes resources of which access is permitted by user devices 12, as for example, a whitelist. The administrator edits the master file 110M and, once ready, copies the master file 110M into the cloud 100 through a network 506, where the copy of the master file 110C is stored.

As it is known in the industry, at some indeterminate time in the future, the copy of the master file 110C is downloaded to the user devices 12 and stored locally as local files 110A. This indeterminate time is dependent upon the cloud software system scheduling the downloads or the period of time that the file is requested by a program running on each user device 12, for example, by the security software 16 running on the user device 12. For example, some security software 16 requests updated files every ten minutes.

Once downloaded, the security software 16 accesses the local file 110A during, for example, virus scanning or determining if a program is allowed to run. Prior to the present disclosure, this indeterminate time ranges from seconds to several minutes, all of which time any changes to the master file 110M are not yet available at the user devices 12 as the master file 110M is not immediately downloaded to update the local files 110A.

To reduce this indeterminate time, the server 500 has a persistent communication link 14 to each security software 16 (the security software 16 runs on every user device 12 that is protected). When the master file 110M is updated, for example, when an administrator using the administrator device 10 adds an entry to the master file 110M, e.g., a new program to a whitelist, a message is sent out in one or more of the persistent communication links 14 and upon recognizing the message, the security software 16 that is running on each user device 12 initiates downloading of the master file 110M to update the local file 110A. Once the local file 110A is downloaded, the change is recognized by the security software 16, for example, the entry that was added to the master file 110M is now reflected in the local file 110A and, the new program is now permitted to run on the user device(s) 12.

In some embodiments, the persistent communication links 14 are named-pipes and a specific message such as “Blackwhiterefresh” is sent to clearly identify the task that the security software 16 need perform, e.g., update the local file 110A (e.g., whitelist/blacklist) from the master file 110M.

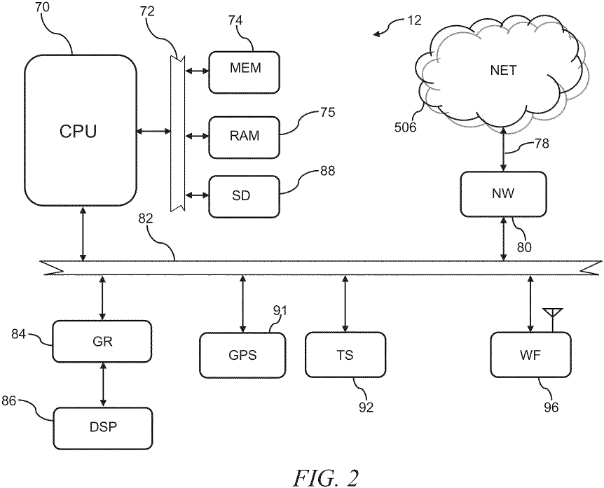

Referring to FIG. 2, a schematic view of an exemplary user device 12 is shown. The exemplary user device 12 is a processor-based device that is protected from malware by security software 16 (see FIG. 1). The present invention is in no way limited to any particular user device 12, as many other processor-based devices are equally anticipated including, but not limited to smart phones, cellular phones, portable digital assistants, routers, thermostats, fitness devices, etc.

The exemplary user device 12 represents a typical device used an end user or employee. This exemplary user device 12 is shown in its simplest form. Different architectures are known that accomplish similar results in a similar fashion, and the present invention is not limited in any way to any particular system architecture or implementation. In this exemplary user device 12, a processor 70 executes or runs programs in a random-access memory 75. The programs are generally stored within a persistent memory 74 and loaded into the random-access memory 75 when needed. In some user devices 12, a removable storage slot 88 (e.g., compact flash, SD) offers removable persistent storage. The processor 70 is any processor, typically a processor designed for phones. The persistent memory 74, random access memory 75, and SIM card are connected to the processor by, for example, a memory bus 72. The random-access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, etc. In some exemplary devices 11, the persistent memory 74 is removable, in the form of a memory card of appropriate format such as SD (secure digital) cards, micro-SD cards, compact flash, etc.

Also connected to the processor 70 is a system bus 82 for connecting to peripheral subsystems such as a network interface 80, a graphics adapter 84 and a touch screen interface 92. The graphics adapter 84 receives commands from the processor 70 and controls what is depicted on the display 86. The touch screen interface 92 provides navigation and selection features.

In general, some portion of the persistent memory 74 and/or the removable storage 88 is used to store programs, executable code, phone numbers, contacts, and data, etc. In some embodiments, other data is stored in the persistent memory 74 such as audio files, video files, text messages, etc.

The peripherals are examples, and other devices are known in the industry such as Global Positioning Subsystems, speakers, microphones, USB interfaces, cameras, microphones, Bluetooth transceivers, Wi-Fi transceivers 96, touch screen interfaces 92, image sensors, temperature sensors, etc., the details of which are not shown for brevity and clarity reasons.

The network interface 80 connects the exemplary user device 12 to the network 506 (e.g., the Internet) through any known or future protocol such as Ethernet, WI-FI, GSM, TDMA, LTE, etc., through a wired or wireless medium. There is no limitation on the type of connection used. The network interface 80 provides data and messaging connections between the exemplary user device 12 and the cloud 100 through the network 506.

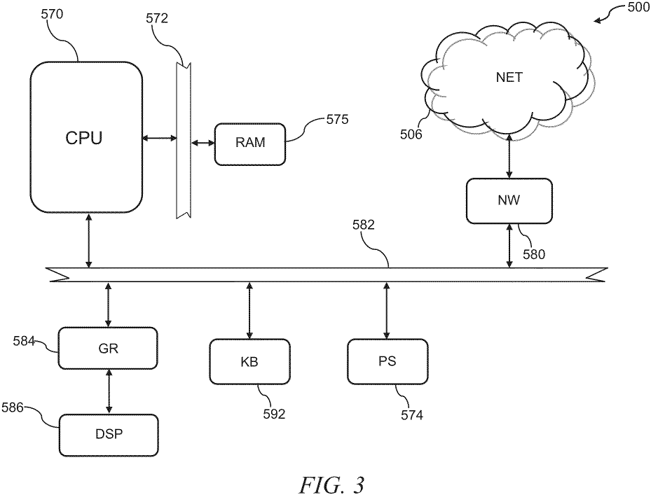

Referring to FIG. 3, a schematic view of a typical server 500 is shown. The exemplary server 500 represents a typical server computer system. Although the exemplary server 500 is shown as a stand-alone system, it is fully anticipated that the server 500 be part of a cloud-computing environment or include multiple computers, one of which is anticipated to be a push server. Different architectures are known that accomplish similar results in a similar fashion and the present invention is not limited in any way to any particular computer system architecture or implementation. In this exemplary computer system, a processor 570 executes or runs programs in a random-access memory 575. The programs are generally stored within a persistent memory 574 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 is typically interfaced to the processor 570 through a system bus 582, or any other interface as known in the industry.

Also shown connected to the processor 570 through the system bus 582 is a network interface 580 (e.g., for connecting to a network 506 - e.g., the Internet), a graphics adapter 584 and a keyboard interface 592 (e.g., Universal Serial Bus - USB). The graphics adapter 584 receives information from the processor 570 and controls what is depicted on a display 586. The keyboard interface 592 provides navigation, data entry, and selection features.

In general, some portion of the persistent memory 574 is used to store programs, executable code, master files 110M, and other data, etc.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

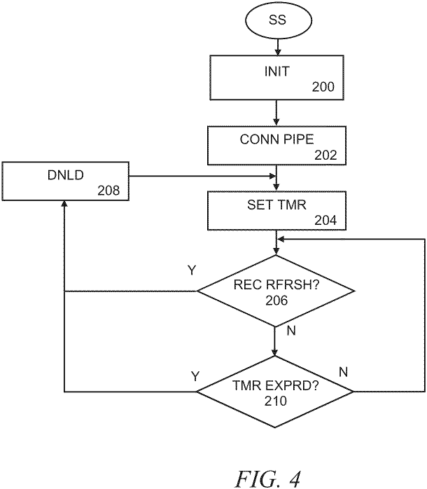

Referring to FIG. 4, an exemplary program flow of the system for expedited delivery is shown. Although shown processing data files for security software 16, the described system is anticipated to be used where ever almost real-time updates to certain files are needed.

In the example of FIG. 4, the security software 16 initializes 200 and the connects 202 to the server 500, for example, through a named-pipe. A loop begins with setting 204 a timer (e.g., setting a timer to 10 minutes). In the loop, a test is performed to check for an incoming refresh message 206 received over the connection with the server 500 (e.g., a specific message is received on the named-pipe). If the incoming refresh message 206 is received, a download 208 is performed such as retrieving a copy of the master file 110C from the cloud 100 or retrieving a copy of the master file 110M from the server 500. Once the download 208 is complete, the loop restarts with setting 204 the timer.

If the incoming refresh message 206 is not received, a test to see if the timer expired 210 is made. If the timer expired 210, the download 208 is performed as above, for example retrieving a copy of the master file 110C from the cloud 100 or retrieving a copy of the master file 110M from the server 500. Once the download 208 is complete, the loop restarts with setting 204 the timer.

If the timer has not expired 210, then the above two tests are repeated.

The above is an exemplary implementation using a polling algorithm and it is equally anticipated to implement the same or similar functionality using interrupt algorithms in which the receipt of the refresh message and/or expiration of the timer interrupts the security software and initiates the download 208.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for computer security, the system comprising:
security software running on a user device, the security software having local data for control of the security software;
a server, the server having storage containing master data for control of the security software;
upon initialization of the security software, the security software connecting to the server by way of a persistent connection; and
after receipt of a refresh message over the persistent connection, the security software downloading the master data and updating the local data from the master data.

2. The system of claim 1, wherein the server is part of a cloud system.

3. The system of claim 2, wherein the master data is stored in cloud storage.

4. The system of claim 1, wherein the persistent connection is a named-pipe.

5. The system of claim 1, wherein the local data for control of the security software is a whitelist.

6. The system of claim 1, wherein the local data for control of the security software is a blacklist.

7. The system of claim 1, wherein the local data for control of the security software is a virus detection file.

8. A method of protecting a user device, the user device having a processor, the method comprising:
installing security software on the user device, the security software running on the processor after the user device is initialized, the security software reading a local data file to control access of the user device to resources;
upon initialization of the security software on the processor, the security software making a persistent connection to a server; and
when receiving a refresh message over the persistent connection, the security software downloading a master data file and updating the local data file from the master data file.

9. The method of claim 8, further comprising:
the security software setting a timer to expire after a predetermined time interval; and
when the timer expires, the security software downloading the master data file and updating the local data file from the master data file.

10. The method of claim 8, wherein the server is part of a cloud system.

11. The method of claim 10, wherein the master data file is stored in cloud storage.

12. The method of claim 8, wherein in the step of the security software making the persistent connection to a server, the security software making the persistent connection to the server by way of a named-pipe.

13. The method of claim 8, wherein the local data file for control of the security software is selected from a group consisting of a whitelist, a blacklist, and a virus detection file.

14. The method of claim 8, wherein the resources include executable programs, scripts, and external network addresses.

15. Program instructions tangibly embodied in a non-transitory storage medium for providing security to a user device, wherein the program instructions comprise:
computer readable instructions running on a processor of the user device after the user device is initialized, the computer readable instructions reading a local data file to control access of the user device to resources;
upon initialization, the computer readable instructions running on the processor creates a persistent connection to a server; and
when the computer readable instructions running on the processor receives a refresh message over the persistent connection, the computer readable instructions running on the processor downloads a master data file and updates the local data file from the master data file.

16. The program instructions tangibly embodied in the non-transitory storage medium of claim 15, wherein the server is part of a cloud system.

17. The program instructions tangibly embodied in the non-transitory storage medium of claim 16, wherein the master data file is stored in cloud storage.

18. The program instructions tangibly embodied in the non-transitory storage medium of claim 15, wherein in the computer readable instructions running on the processor makes the persistent connection to a server by way of a named-pipe.

19. The program instructions tangibly embodied in the non-transitory storage medium of claim 15, wherein the local data file for control of the computer readable instructions running on the processor is selected from a group consisting of a whitelist, a blacklist, and a virus detection file.

20. The program instructions tangibly embodied in the non-transitory storage medium of claim 15, wherein the resources include executable programs, scripts, and external network addresses.
